(19) United States
(12) Patent Application Publication
(10) Pub. No.: US 2008/0143843 A1
(43) Pub. Date: Jun. 19, 2008

(54) METHOD OF EXECUTING AN IMAGE PROCESSING PROCEDURE AND A RELATED DIGITAL IMAGE CAPTURING DEVICE

(76) Inventor: Chun-Chang Wang, Hsinchu City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/684,475

(22) Filed: Mar. 9, 2007

(30) Foreign Application Priority Data
Dec. 13, 2006 (TW) 095146774

(51) Int. Cl. H04N 5/228

(52) U.S. Cl. 348/222.1; 348/E05.031

(57) ABSTRACT

A method of executing an image processing procedure is disclosed. The method is used in a digital image capturing device. The image processing procedure comprises a readout period and a sweep period. The method comprises the steps of: dividing an image of a frame into a plurality of regions; choosing at least one region for the readout period; choosing at least one region for the sweep period; and executing the image processing procedure.

### BACKGROUND OF THE INVENTION

1. Field of the Invention

The present invention relates to an image processing procedure, and more particularly, to a method of partially executing an image processing procedure.

2. Description of the Related Art

In today's technology, digital image capturing devices are extremely popular devices, and users are demanding increasingly better performance from digital image capturing devices. When the digital image capturing device performs an auto exposure, an auto focusing or an auto white-balancing procedure, a complete image must be downloaded for analysis. However, this method requires a relatively long processing time. In some types of prior art technology, although certain digital image capturing devices do not need to download an entire image, they cannot randomly download a non-continuous image. For example, the upper half or middle portions of the downloaded image are fixed regions with a continuous range.

In the prior art technology, the digital image capturing device may utilize an additional timing generator to increase the image analysis speed. However, this increased speed results from the timing generator itself, and cannot be changed. As a result, such a processing procedure requires a relatively longer time and requires more resources.

Therefore, it is desirable to provide a method of accelerating the image processing procedure for a digital image capturing device to mitigate and/or obviate the aforementioned problems.

### SUMMARY OF THE INVENTION

A main objective of the present invention is to provide a method of partially executing an image processing procedure for a digital image capturing device.

In order to achieve the above-mentioned objective, the digital image capturing device comprises a processor, a timing generator, and a digital image capturing module. The processor is used for executing the various procedures of the digital image capturing device. The digital image capturing module comprises a plurality of photo diodes for performing an exposure procedure. The timing generator is used for controlling an image capturing procedure of the digital image capturing module.

The method of executing an image processing procedure of the present invention comprises: dividing an image of a frame into a plurality of regions; dividing a charge transfer period, a sweep period, and a readout period into these regions; and setting a processing time schedule for the timing generator.

The timing generator executes the image processing procedure. The timing generator calculates the total number of regions processed in the charge transfer period, the sweep period and the readout period to determine whether this total value equals the number of the regions used to divide the image. The timing generator immediately ends the frame to perform the image processing procedure for the next frame.

The method of the present invention may therefore reduce the analysis time required by the digital image capturing device, which increases the image processing speed.

These and other novel features of the invention will become more apparent from the following detailed description when taken in conjunction with the accompanying drawings.

### BRIEF DESCRIPTION OF THE DRAWINGS

FIG. 1 illustrates the hardware of a digital image capturing device according to the present invention.

FIG. 2 is a flowchart of a digital image capturing device executing an image processing procedure according to the present invention.

FIGS. 3A˜3D show a sectional image processing procedure of a digital image capturing device according to the present invention.

### DETAILED DESCRIPTION OF THE PREFERRED EMBODIMENT

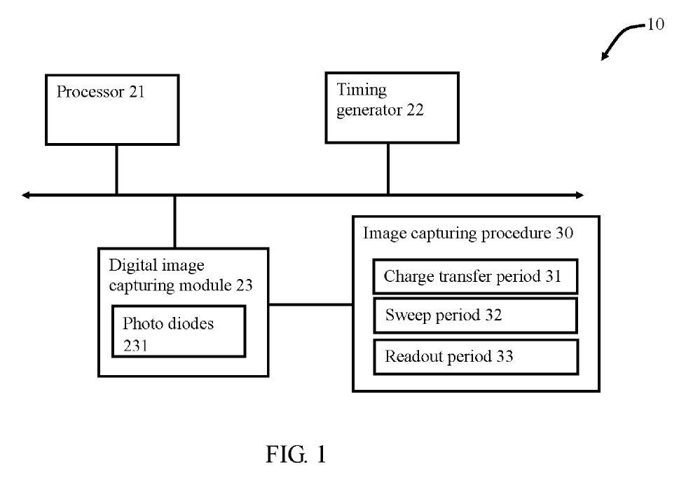

Please refer to FIG. 1. FIG. 1 shows the hardware of a digital image capturing device according to the present invention. A digital image capturing device 10 may be a digital camera, a digital video camera or another equivalent device. The digital image capturing device 10 of the present invention comprises a processor 21, a timing generator 22, a digital image capturing module 23, and other associated components. All of the elements are electrically connected to each other. The processor 21 is used to provide all of the processing-related functionality of the digital image capturing device 10. The digital image capturing module 23 may include CCD elements or CMOS elements for capturing images; in this embodiment, CCD elements are utilized. The digital image capturing module 23 comprises a plurality of photo diodes 231 for performing an exposure procedure.

The timing generator 22 is used for flexibly controlling an image capturing procedure 30 of the digital image capturing module 23. In general, the image capturing procedure 30 of the digital image capturing module 23 comprises a charge transfer period 31, a sweep period 32 and a readout period 33, with each period controlled by the timing generator 22.

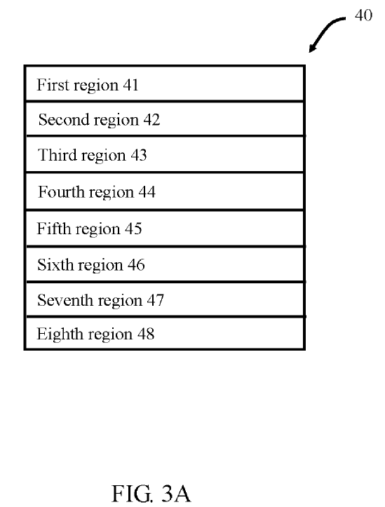

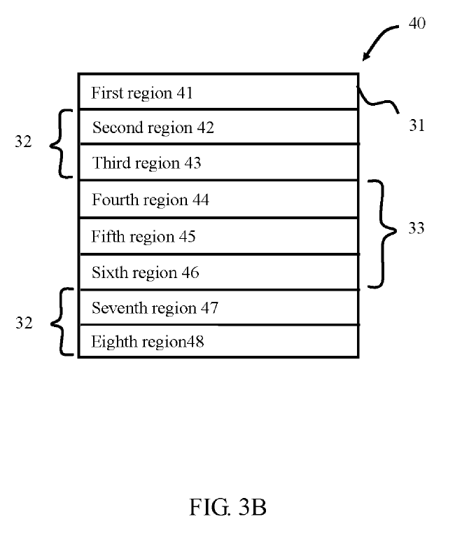

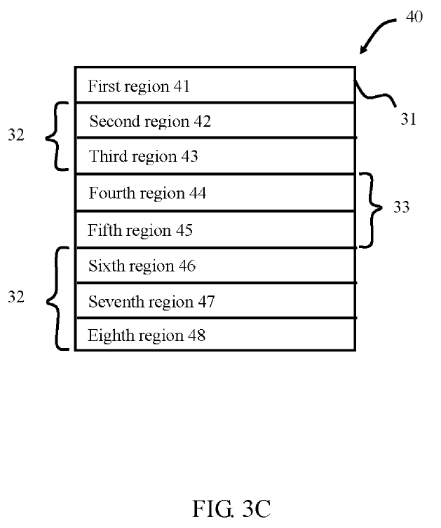

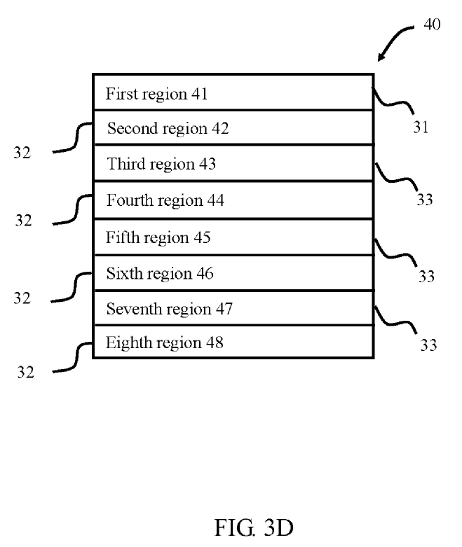

The charge transfer period 31 of the digital image capturing module 23 is used for transferring charges from the exposed photo diodes 231. The sweep phase 32 is used to clear data remaining from a previous frame in the image processing procedure 30. The assigned to the charge transfer period 31, while the readout period 33 uses the fourth region 44 and the fifth region 45. Other regions are assigned to the sweep period 32. Comparing the embodiment shown in FIG. 3B to the embodiment shown in FIG. 3C, fewer regions used for the readout period 33. Consequently, the processor 21 subsequently requires less analysis time, which can increase the processing speed of the processor 21.

Another embodiment is shown in FIG. 3D. In FIG. 3D, the sweep period 32 and the readout period 33 are not assigned continuous regions. The second region 42, the fourth region 44, the sixth region 46 and the eighth region 48 are assigned to the sweep period 32. The third region 43, the fifth region 45 and the seventh region 47 are assigned to the readout period 33. Although the total number of regions is the same, the selected regions can be continuous or non-continuous images. Moreover, various arrangements are possible when assigning regions to the sweep period 32 and the readout period 33.

After the regions are assigned, the timing generator 22 is used to set a processing time schedule for the image processing procedure 30. That is, the timing generator 22 is used to decide when to execute the sweep period 32 or the readout period 33.

Step 203: performing the image processing procedure 30.

The timing generator 22 executes the image processing procedure 30. According to the processing time scheduled in step 202, the timing generator 22 controls the digital image capturing module 23 to perform the image processing procedure 30.

Step 204: determining whether the procedure has finished.

The timing generator 22 checks if the image processing procedure 30 has finished. The timing generator 22 calculates the total number of regions processed in the charge transfer period 31, the sweep period 32 and the readout period 33 to determine whether this total value equals the number of the regions used to divide the image. If it is not, step 203 is executed until the image processing procedure 30 has finished. If it is, the image processing procedure 30 for the frame 40 is finished, and step 205 is executed. readout phase 33 is used for reading image data values for the processor 21 to subsequently perform other procedures, such as an auto exposure, an auto focusing or an auto white-balancing procedure, etc.

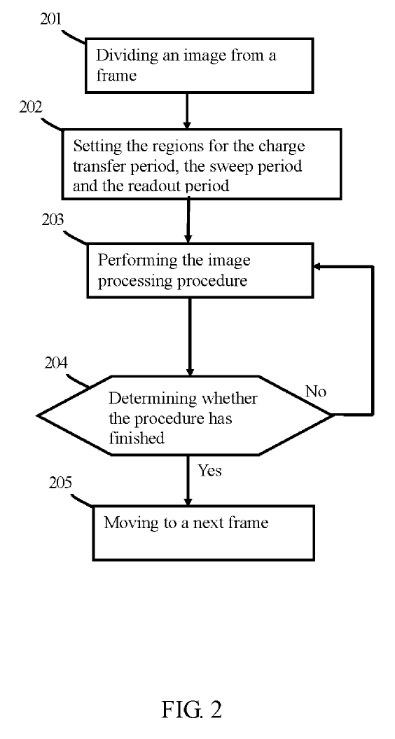

Please refer to FIG. 2 and FIGS. 3A˜3D. FIG. 2 is a flowchart of a digital image capturing device executing an image processing procedure according to the present invention. FIGS. 3A˜3D show a sectional image processing procedure of a digital image capturing device according to the present invention.

The digital image capturing device 10 first executes step 201: dividing an image from a frame 40.

First, the digital image capturing device 10 divides an image from a frame 40, as shown in FIG. 3A. In this embodiment, the image from the frame 40 is divided into eight regions, which are a first region 41 to an eighth region 48 that are used for subsequent image processing. However, it will be appreciated that the present invention may use other numbers of regions.

In step 202: setting the regions for the charge transfer period 31, the sweep period 32 and the readout period 33.

As shown in FIG. 3B, the charge transfer period 31, the sweep period 32 and the readout period 33 are divided into these eight regions. The first region 41 is selected for the charge transfer period 31. The second region 42 through the eighth region 48 may be assigned to the sweep period 32 or the readout period 33. In FIG. 3B, the second region 42, the third region 43, the seventh region 47 and the eighth region 48 are assigned to the sweep period 32, while the fourth region 44 through sixth region 46 are assigned to the readout period 33. As a result, there is no need to read all images in the frame 40, which speeds up the image processing speed.

The assigning method shown in FIG. 3B is not the only assigning method that may be used; another assigning method is shown in FIG. 3C. In FIG. 3C, the first region 41 is still

Step 205: moving to a next frame.

The timing generator 22 immediately ends the frame 40 to perform the image processing procedure 30 for the next frame. The image processing procedure 30 of the next frame may also utilize step 202 to assign regions.

The method of the present invention may therefore reduce the analysis time required by the digital image capturing device 10, which increases the image processing speed.

Although the present invention has been explained in relation to its preferred embodiment, it is to be understood that many other possible modifications and variations can be made without departing from the spirit and scope of the invention as hereinafter claimed.

What is claimed is:

1. A method of executing an image processing procedure for a digital image capturing device, wherein the image processing procedure comprises a readout period and a sweep period, the method comprising:
dividing an image of a frame into a plurality of regions;
selecting at least one region for the readout period;
selecting at least one region for the sweep period; and
executing the image processing procedure.

2. The method of executing an image processing procedure as claimed in claim 1, wherein the image processing procedure further comprising a charge transfer procedure;
and the method further comprising: selecting at least one region for the charge transfer procedure.

3. The method of executing an image processing procedure as claimed in claim 2, wherein the charge transfer procedure is executed first.

4. The method of executing an image processing procedure as claimed in claim 1 further comprising: determining a sum of regions processed in the sweep period and in the readout period.

5. The method of executing an image processing procedure as claimed in claim 1, wherein the step of selecting at least one region as the readout period further comprises selecting continuous regions.

6. The method of executing an image processing procedure as claimed in claim 1, wherein the step of selecting at least one region as the readout period further comprises selecting non-continuous regions.

7. A digital image capturing device capable of executing an image processing procedure, the digital image capturing device comprising:
a processor;
a digital image capturing module electrically connected to the processor; and
a timing generator electrically connected to the digital image capturing module and used for controlling the digital image capturing module to execute an image processing procedure;
wherein the image processing procedure comprises a readout period and a sweep period;
the processor controlling the timing generator and the digital image capturing module to achieve the following means:
dividing an image of a frame into a plurality of regions;
selecting at least one region for the readout period;
selecting at least one region for the sweep period; and
executing the image processing procedure.

8. The digital image capturing device as claimed in claim 7, wherein the image processing procedure further comprises a charge transfer procedure; and at least one region is selected for the charge transfer procedure.

9. The digital image capturing device as claimed in claim 8, wherein the timing generator executes the charge transfer procedure first.

10. The digital image capturing device as claimed in claim 7, wherein the timing generator is also used for determining a sum of regions processed in the sweep period and in the readout period.

11. The digital image capturing device as claimed in claim 7, wherein the readout period uses continuous regions.

12. The digital image capturing device as claimed in claim 7, wherein the readout period uses non-continuous regions.

13. The digital image capturing device as claimed in claim 7, wherein the device further comprises a plurality of photo diodes.

14. The digital image capturing device as claimed in claim 7, wherein the digital image capturing device is a digital camera or a digital video camera.
